(19) United States
(12) Patent Application Publication
(10) Pub. No.: US 2026/0145486 A1
(43) Pub. Date: May 28, 2026

(54) AUTOMOTIVE HOT GAS HEAT PUMP SYSTEM AND CONTROLLING METHOD THEREOF

(71) Applicants: HYUNDAI MOTOR COMPANY, SEOUL (KR); KIA CORPORATION, SEOUL (KR)

(72) Inventors: Jeawan Kim, Hwaseong-si (KR); Jungmo Yu, Hwaseong-si (KR)

(73) Assignees: HYUNDAI MOTOR COMPANY, SEOUL (KR); KIA CORPORATION, SEOUL (KR)

(21) Appl. No.: 19/225,603

(22) Filed: Jun. 2, 2025

(30) Foreign Application Priority Data
Nov. 22, 2024 (KR) 10-2024-0169003

(51) Int. Cl. B60H 1/32; B60H 1/00

(52) U.S. Cl. CPC B60H 1/3213; B60H 1/00278

(57) ABSTRACT

An automotive hot gas heat pump system includes: a sensor unit; a hot gas heat pump device; an air conditioning control unit; and a hot gas mode heat source generator. The hot gas heat pump device includes a hot gas bypass valve configured to open and close a path through which a gaseous refrigerant branched and supplied from a compressor enters the compressor. The air conditioning control unit is configured to control the hot gas heat pump device to be operated in a normal heat pump mode or a hot gas mode based on a heat absorption amount based on temperature and heating load. The hot gas mode heat source generator is configured to extract a current vector from an inefficient current map in response to torque command value, and generate a PE heat source by driving a driving motor in an inefficient mode based on the extracted current vector.

### CROSS-REFERENCE TO RELATED APPLICATION

This application claims priority to and the benefit of Korean Patent Application No. 10-2024-0169003 filed at the Korean Intellectual Property Office on Nov. 22, 2024, the entire contents of which are incorporated herein by reference.

### BACKGROUND

### (a) Technical Field

The present disclosure relates to an automotive hot gas heat pump system and a controlling method thereof. More particularly, the present disclosure relates to an automotive hot gas heat pump system for efficiently operating a hot gas mode by securing a heat source through inefficient control of a motor using an inefficient current map in the hot gas mode, and a controlling method thereof.

### (b) Description of the Related Art

An automobile may generally include an air conditioning system (hereinafter also referred to as an “air conditioning device”) to regulate an interior air temperature. This automotive air conditioning device may generate warm air to maintain an interior of an automobile warm in the winter and generate cold air to maintain the interior cool in the summer.

Generally, an automotive air conditioning device, a compressor, a condenser, an expansion valve, and an evaporator are sequentially connected with each other along a refrigerant pipe, and a refrigerant may be circulated as the compressor is driven by engine power. The automotive air conditioning device may convert a refrigerant gas compressed to a high temperature and a high pressure by the compressor into a liquid state by exchanging heat with surrounding air as the refrigerant gas passes through the condenser, and the liquefied refrigerant may be changed into a low-temperature gas as the refrigerant passes through the expansion valve. In addition, the vaporized low-temperature refrigerant may be cooled or heated while exchanging heat with the surrounding air as the refrigerant passes through the evaporator, and the cooled or heated air may be discharged into the automobile interior by a blower. The low-temperature gaseous refrigerant that passed through the evaporator may return to the compressor and be repeatedly circulated through a process of being compressed to the high temperature and the high pressure.

Recently, an electric automobile that uses electric energy as a power source has been released, and the air conditioning device (heating device) installed in the electric automobile may heat the interior of the automobile through an electric heater that heats water or air by using power supplied from a battery. As a result, significant reduction in power performance of the electric automobile occurs.

For this reason, a heating device for an electric automobile or the like uses a heat pump system in addition to the electric heater. The heat pump system may be a combined cooling and heating system that combines cooling and heating by reversibly applying a compression-condensation-decompression-evaporation cycle of the refrigerant.

FIG. 1 is a diagram showing a conventional heating system used in an electric automobile.

Referring to FIG. 1, the conventional heating system in an electric automobile may include a heat pump system 20 and a positive temperature coefficient (PTC) electric heater 10, combined with each other.

The heat pump system 20 is a heating device that absorbs heat from a low-temperature heat source 30 and generates heat by using a high-temperature heat source rather than producing heat on its own. The heat source 30 may include a power electronics (PE) heat source 31 generated by a power electronics module (hereinafter, also referred to as the “PE module”), an exterior heat source 32, and a heat source 33 generated by a battery. A power electronics (PE) module is a component designed to combine a drive/driving system of the electric automobile into small parts, the drive/driving system replacing functions of the engine and transmission in a conventional internal combustion engine automobile, and refers to a drive motor, a reducer, an inverter for power conversion, or the like.

The heat pump system 20 may have excellent heating performance and efficiency when heat absorption source is sufficient, and may have lower heating performance and efficiency when the heat absorption source is insufficient. Accordingly, if the heat absorption source is insufficient, it is difficult to respond to a heating load by using only the heat pump system 20, and the relatively low-efficiency PTC electric heater 10 may be used to respond to the load.

However, this electric automobile heating method requires the addition of the separate PTC electric heater 10 in addition to the heat pump system 20, which may result in an additional cost and an increased volume.

The battery in the electric automobile may be mainly made of a lithium-ion battery. Lithium-ion batteries have excellent energy density at room temperature and excellent performance when considering charge and discharge cycles. However, lithium-ion batteries may have reduced capacity, increased resistance, and decreased efficiency at low temperature due to a property of an electrolyte included in the lithium-ion battery. In particular, when charging a lithium-ion battery at low temperature, lithium ions may be unevenly deposited on a surface of a negative electrode, thus shortening its lifespan. This problem requires a heating device capable of rapidly raising a temperature of the lithium-ion battery from a low temperature state to a high temperature state where the battery has high efficiency.

FIG. 2 is a schematic diagram of a conventional battery heating device used in an electric automobile. A conventional battery heating method uses a method of directly heating a battery 50 by adding a PTC electric heater 42 or circulating a coolant supplied to the battery 50 by heating the coolant through an electronic water pump (also referred to as “EWP”) 41. However, this conventional battery heating method requires the addition of the separate PTC electric heater 42, which may result in the additional cost and the increased volume.

### SUMMARY

The present disclosure provides an automotive hot gas heat pump system capable of heating an electric automobile without a positive temperature coefficient (PTC) electric heater even when a heat absorption source is insufficient, and a controlling method thereof.

In addition, the present disclosure provides an automotive hot gas heat pump system capable of heating a battery without any PTC electric heater, and a controlling method thereof.

According to an embodiment, provided is an automotive hot gas heat pump system including a sensor unit configured to measure a temperature of at least one of the exterior heat source, power electronics (PE) heat source, and battery heat source of an automobile. The system also includes a hot gas heat pump device including a condenser configured to release heat by condensing a high-temperature and high-pressure gaseous refrigerant supplied from a compressor and a hot gas bypass valve configured to open and close a path through which the high-temperature and high-pressure gaseous refrigerant branched and supplied from the compressor enters the compressor. The hot gas heat pump device is also configured to operate in a normal heat pump mode or a hot gas mode in response to the opening or closing operation of the hot gas bypass valve. The system also includes an air conditioning control unit configured to control the hot gas heat pump device to be operated in the normal heat pump mode or the hot gas mode based on a heat absorption amount based on the temperature measured by the sensor unit and a heating load. The air conditioning control unit is also configured to generate a hot gas mode entry flag when the hot gas heat pump device is operated in the hot gas mode. The system also includes a hot gas mode heat source generator configured to extract a current vector from an inefficient current map in response to a torque command value received from an automobile controller. The hot gas mode heat source generator is also configured to generate the PE heat source by driving a driving motor in an inefficient mode based on the extracted current vector, in response to the hot gas mode entry flag received from the air conditioning control unit.

The air conditioning control unit may generate a heat absorption amount for the operation in the hot gas mode. The hot gas mode heat source generator may extract the current vector from the inefficient current map in response to the heat absorption amount generated by the air conditioning control unit and the torque command value received from the automobile controller.

The hot gas heat pump device may include the condenser configured to release heat by condensing the high-temperature and high-pressure gaseous refrigerant that passed through the compressor and convert the high-temperature and high-pressure gaseous refrigerant into a high-temperature and high-pressure liquid refrigerant. The hot gas heat pump device may also include: an expansion valve configured to generate a low-temperature and low-pressure two-phase refrigerant by expanding the high-temperature and high-pressure liquid refrigerant supplied from the condenser; an evaporator configured to convert the low-temperature and low-pressure two-phase refrigerant into a low-temperature and low-pressure gaseous refrigerant by absorbing heat from the exterior heat source; and the compressor configured to generate the high-temperature and high-pressure gaseous refrigerant by compressing the low-temperature and low-pressure gaseous refrigerant supplied from the evaporator, and provide the generated high-temperature and high-pressure gaseous refrigerant to the condenser. Additionally, the hot gas heat pump device may include: the hot gas bypass valve configured to open and close the path through which the high-temperature and high-pressure gaseous refrigerant branched and supplied from the compressor enters the compressor, in response to the control of the air conditioning control unit; and an accumulator disposed between the evaporator and the compressor. The accumulator is configured to prevent the liquid refrigerant from being supplied to the compressor.

In the normal heat pump mode, the high-temperature and high-pressure gaseous refrigerant discharged from the compressor may be entirely supplied to the condenser in response to the control of the air conditioning control unit. In the hot gas mode, a portion of the high-temperature and high-pressure gaseous refrigerant discharged from the compressor may be branched and converted into a medium-temperature gaseous refrigerant through the hot gas bypass valve and supplied to the compressor by passing through the accumulator.

In the hot gas mode, the accumulator may convert the low-temperature and low-pressure two-phase refrigerant into the low-temperature and low-pressure gaseous refrigerant by mixing and exchanging heat between the low-temperature and low-pressure two-phase refrigerant that passed through the evaporator and the medium-temperature gaseous refrigerant that passed through the hot gas bypass valve.

Heat released from the condenser may be used for automobile heating or battery heating.

The hot gas mode heat source generator may include the driving motor configured to generate a torque by being operated by a three-phase alternating current (AC) voltage, and a motor control unit configured to perform the inefficient control of the driving motor by using the inefficient current map.

The motor control unit may include: an efficient current map configured to store a combination of the current vectors that is capable of producing a maximum torque per unit current in the driving motor; the inefficient current map configured to store a combination of the current vectors for driving the driving motor in the inefficient mode; a current command generation unit configured to generate a current command value from the inefficient current map based on the torque command value received from the automobile controller and the hot gas mode entry flag received from the air conditioning control unit; and a current control unit configured to generate a voltage command value by using the current command value generated by the current command generation unit. The motor control unit may also include: a pulse width modulation (PWM) control unit configured to generate a duty value corresponding to the voltage command value generated by the current control unit; and an inverter configured to drive the driving motor by varying a frequency of the AC voltage based on the duty value received from the PWM control unit.

In the normal heat pump mode, the motor control unit may control the driving motor by generating the current command value from the efficient current map based on the torque command value received from the automobile controller.

The inefficient current map may include a plurality of inefficient current maps having different inefficient control levels of the driving motor. The motor control unit may select a first inefficient current map corresponding to the heat absorption amount received from the air conditioning control unit from the plurality of inefficient current maps in response to the hot gas mode entry flag received from the air conditioning control unit, and control the driving motor by selecting the current command value corresponding to the torque command value received from the automobile controller from the first inefficient current map.

According to an embodiment, a controlling method of an automotive hot gas heat pump system is provided. The method includes: checking, by an air conditioning control unit, a heat absorption amount level based on a temperature of an exterior heat source measured by a sensor unit; determining, by the air conditioning control unit, whether to enter a hot gas mode based on the heat absorption amount level and a heating load; and transmitting a hot gas mode entry flag to a hot gas mode heat source generator when it is determined, by the air conditioning control unit, to enter the hot gas mode. The method also includes: extracting, by the hot gas mode heat source generator, a current vector from an inefficient current map in response to a torque command value received from an automobile controller; and generating a power electronics (PE) heat source by driving a driving motor in an inefficient mode based on the extracted current vector, in response to the hot gas mode entry flag received from the air conditioning control unit.

The method may further include determining a heat absorption amount in the hot gas mode in which the air conditioning control unit is capable of achieving the heating load. In the generating of the PE heat source, the current vector is extracted from the inefficient current map in response to the heat absorption amount received from the air conditioning control unit and the torque command value received from the automobile controller.

The inefficient current map may include a plurality of inefficient current maps having different inefficient control levels of the driving motor. The generating of the PE heat source may include: selecting a first inefficient current map corresponding to the heat absorption amount received from the air conditioning control unit from the plurality of inefficient current maps in response to the hot gas mode entry flag received from the air conditioning control unit; and controlling the driving motor by selecting the current command value corresponding to the torque command value received from the automobile controller from the first inefficient current map.

As set forth above, the automotive hot gas heat pump system and the controlling method thereof according to the embodiments may generate the PE heat source through the inefficient control of the motor by using the inefficient current map even when the heat absorption source is insufficient, and use the generated PE heat source as the heat absorption source in the hot gas mode to heat the automobile or increase the battery temperature.

### BRIEF DESCRIPTION OF THE DRAWINGS

FIG. 1 is a diagram showing a conventional heating system used in an electric automobile.

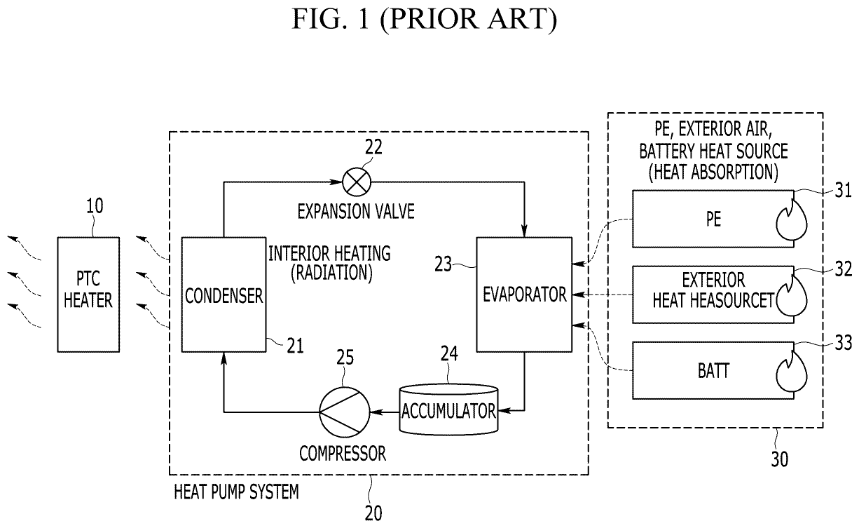

FIG. 2 is a schematic diagram of a conventional battery heating device used in an electric automobile.

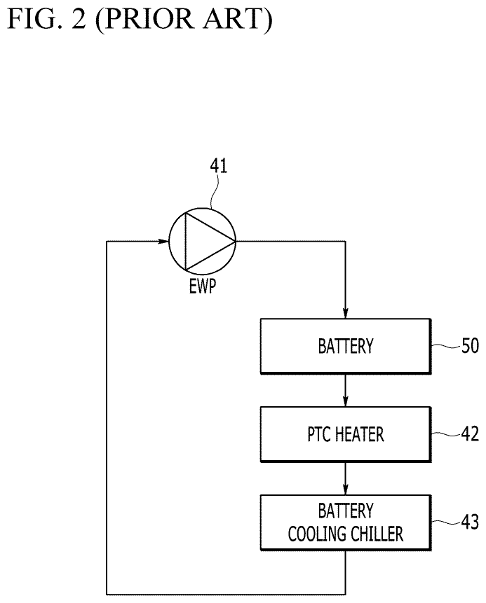

FIG. 3 is a block diagram of an automotive hot gas heat pump system according to an embodiment of the present disclosure.

FIG. 4 is a diagram detailing a configuration of a hot gas heat pump device according to an embodiment of the present disclosure.

FIG. 5 is a diagram showing an operation of the hot gas heat pump device of FIG. 4 in a heat pump mode.

FIG. 6 is a diagram showing an operation of the gas heat pump device of FIG. 4 in a hot gas mode.

FIG. 7 is a diagram detailing a configuration of a hot gas heat pump device according to another embodiment of the present disclosure.

FIG. 8 is a diagram showing an operation of the hot gas heat pump device of FIG. 7 in the heat pump mode.

FIG. 9 is a diagram showing an operation of the hot gas heat pump device of FIG. 7 in the hot gas mode.

FIG. 10 is a diagram detailing a configuration of a hot gas mode heat source generator according to an embodiment of the present disclosure.

FIG. 11 is a diagram showing a combination of current vectors (id, iq) capable of generating the same torque Te.

FIG. 12 is a control flowchart of the hot gas mode heat source generator according to an embodiment of the present disclosure.

### DETAILED DESCRIPTION

Hereinafter, embodiments of the present disclosure are described in detail with reference to the accompanying drawings so that those having ordinary skill in the art to which the present disclosure pertains may easily practice the present disclosure. However, the present disclosure may be implemented in various different forms and is not limited to the embodiments provided herein. In addition, in the drawings, portions unrelated to the description are omitted to clearly describe the present disclosure, and similar portions are denoted by similar reference numerals throughout the specification.

Throughout the specification, when any one part “includes” any one component, it may indicate the inclusion of other components rather than the exclusion of other components unless explicitly described to the contrary.

In addition, a term “part”, “˜er/or”, “module”, or the like, described in the specification indicate a unit of processing at least one function or operation and may be implemented by hardware, software, or a combination of hardware and software.

The devices described in the present disclosure may include hardware including at least one processor, memory device, communication device, or the like, and store a program executed in combination with the hardware in a designated location. The hardware may have the configuration and capability to perform a method of the present disclosure. The program may include instructions for implementing an operation method of the present disclosure described with reference to the drawings, and execute the present disclosure in combination with the hardware such as the processor and the memory device.

In the specification, “transmission” or “provision” may include not only direct transmission or provision, but also indirect transmission or provision through another device or using a bypass path.

In the specification, a term of a singular number may be interpreted as the singular number or its plural number unless explicitly expressed such as “one” or “single”.

When a component, device, element, or the like of the present disclosure is described as having a purpose or performing an operation, function, or the like, the component, device, or element should be considered herein as being “configured to” meet that purpose or perform that operation or function.

Hereinafter, the embodiments of the present disclosure are described in detail with reference to the accompanying drawings. In the drawings, the same reference numbers are used to indicate the same or similar components.

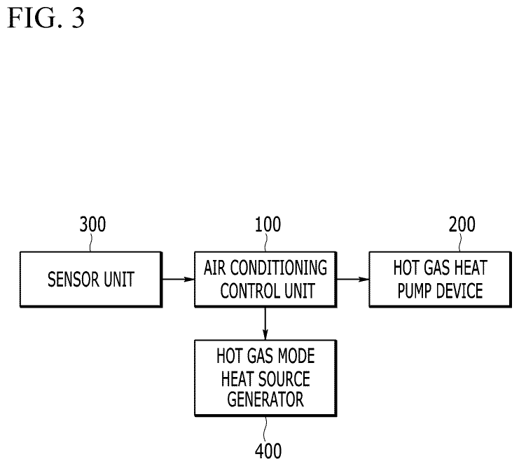

FIG. 3 is a block diagram of an automotive hot gas heat pump system according to an embodiment of the present disclosure.

Referring to FIG. 3, the automotive hot gas heat pump system according to an embodiment of the present disclosure may include an air conditioning control unit 100, a hot gas heat pump device 200, a sensor unit 300, and a hot gas mode heat source generator 400.

The sensor unit 300 may measure an automobile exterior temperature, a temperature generated by a power electronics (PE) module (hereinafter, referred to as the “PE temperature”), a temperature generated by a battery (hereinafter, referred to as the “battery temperature”), and an automobile interior temperature.

The air conditioning control unit 100 may control an operation of the hot gas heat pump device 200 based on the exterior temperature, PE temperature, interior temperature, or the like of an automobile, measured by the sensor unit 300. In detail, the air conditioning control unit 100 may control the hot gas heat pump device 200 to be operated in a heat pump mode or a hot gas mode based on the exterior temperature, PE temperature, battery temperature, or interior temperature of the automobile, measured by the sensor unit 300. In addition, the air conditioning control unit 100 may transmit a hot gas mode entry flag and a heat absorption amount to the hot gas mode heat source generator 400 when the hot gas heat pump device 200 is operated in the hot gas mode.

The hot gas mode heat source generator 400 may extract a current vector from an inefficient current map in response to the heat absorption amount received from the air conditioning control unit 100 and a torque command received from an automobile controller. The hot gas model heat source generator may also generate the PE heat source by driving a driving motor of the electric automobile in an inefficient mode based on the extracted current vector when the hot gas mode entry flag and the heat absorption amount are received from the air conditioning control unit 100.

The hot gas heat pump device 200 may be operated in a normal heat pump mode or the hot gas mode based on control of the air conditioning control unit 100.

According to an embodiment of the present disclosure, the hot gas mode is a technology to overcome a situation where a heat absorption source desired for heat pump is insufficient under an extremely low temperature condition or a cold start condition. Additionally, the hot gas mode is a technology to prevent a compressor suction pressure from falling below a desired setting or less by bypassing a portion of a high-temperature gaseous refrigerant discharged from a compressor to an inlet of the compressor.

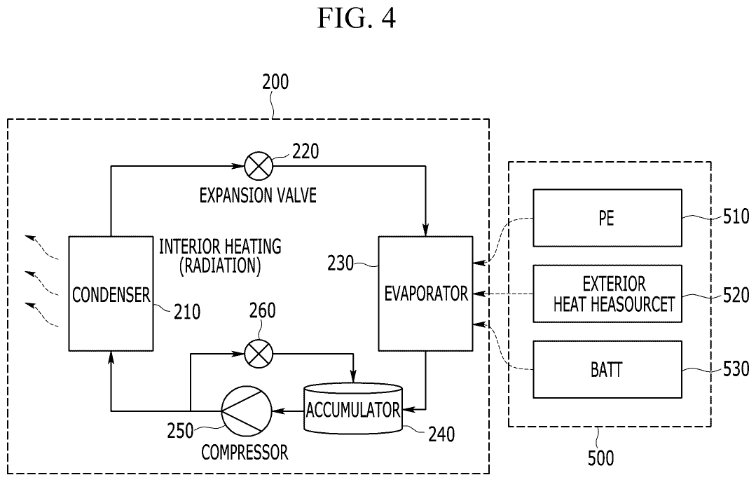

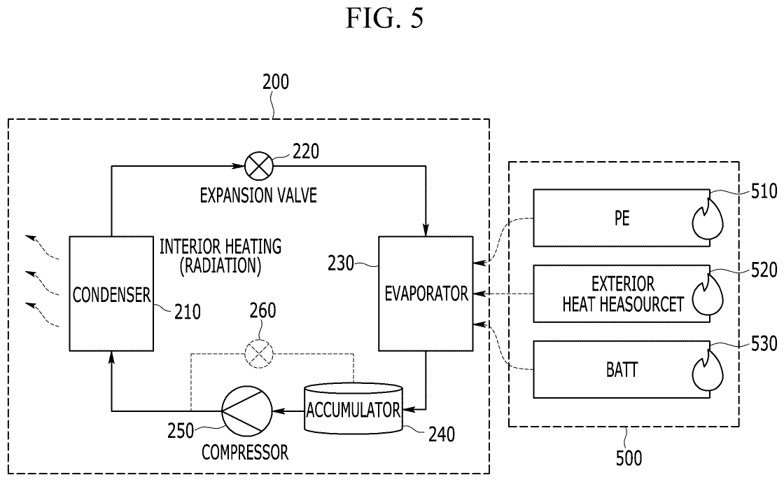

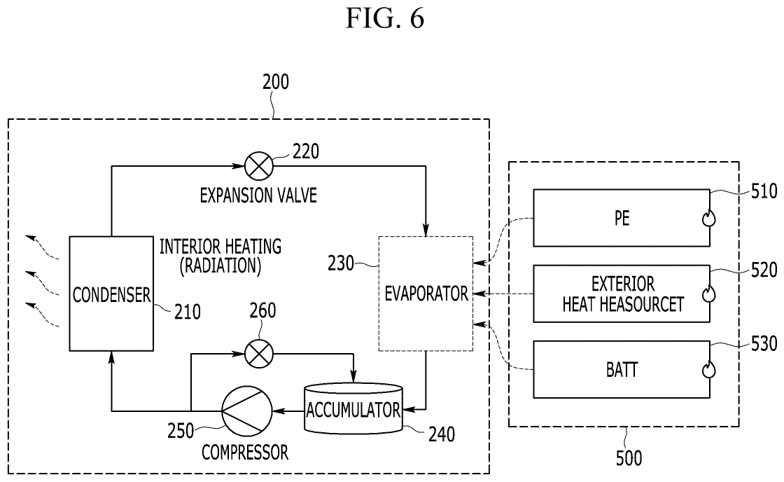

FIG. 4 is a diagram detailing a configuration of the hot gas heat pump device 200 according to an embodiment of the present disclosure. FIG. 5 is a diagram showing an operation of the hot gas heat pump device 200 of FIG. 4 in the heat pump mode. FIG. 6 is a diagram showing an operation of the hot gas heat pump device 200 of FIG. 4 in the hot gas mode. The hot gas heat pump device according to an embodiment of the present disclosure shown in FIGS. 4-6 may be used as a heating device for the electric automobile.

Referring to FIG. 4, the hot gas heat pump device 200 may include a condenser 210, an expansion valve 220, an evaporator 230, an accumulator 240, a compressor 250, and a hot gas bypass valve 260.

The condenser 210 may release heat by condensing a high-temperature and high-pressure gaseous refrigerant that passed through the compressor 250, and convert the gaseous refrigerant into a high-temperature and high-pressure liquid refrigerant. Heat released from the condenser 210 may be used for automobile heating.

The expansion valve 220 may generate a low-temperature and low-pressure two-phase refrigerant by expanding the high-temperature and high-pressure liquid refrigerant supplied from the condenser 210. The two-phase refrigerant indicates a refrigerant in which its gas and liquid states are mixed with each other.

The evaporator 230 may convert the two-phase refrigerant into the low-temperature and low-pressure gaseous refrigerant by absorbing heat from an exterior heat source 500. In an embodiment of the present disclosure, the exterior heat source 500 may include a PE heat source 510, an exterior heat source 520, and a battery heat source 530.

The compressor 250 may discharge the high-temperature and high-pressure gaseous refrigerant by compressing the gaseous refrigerant supplied from the evaporator 230, and transmit the discharged gaseous refrigerant to the condenser 210. The high-temperature and high-pressure gaseous refrigerant discharged from the compressor 250 may be supplied entirely to the condenser 210 or partially branched and supplied to the hot gas bypass valve 260 based on a heating mode (first heating mode or second heating mode) under control of the air conditioning control unit 100.

The hot gas bypass valve 260 may open or close a path through which the high-temperature and high-pressure gaseous refrigerant branched and supplied from the compressor 250 re-enters the compressor 250 under the control of the air conditioning control unit 100. In detail, as shown in FIG. 5, the hot gas bypass valve 260 may block the path through which the high-temperature and high-pressure gaseous refrigerant branched and supplied from the compressor 250 re-enters the compressor 250 in the heat pump mode (first heating mode). In addition, as shown in FIG. 6, the hot gas bypass valve 260 may convert the high-temperature and high-pressure gaseous refrigerant branched and supplied from the compressor 250 into a medium-temperature gaseous refrigerant in the hot gas mode (second heating mode), thus allowing the refrigerant to enter the compressor 250 by passing through the accumulator 240. FIGS. 4 and 6 show that the medium-temperature gaseous refrigerant that passed through the hot gas bypass valve 260 directly enters the accumulator 240. However, the present disclosure is not limited thereto, and the refrigerant may be supplied to a refrigerant pipe adjacent to an inlet of the evaporator 230 or an outlet of the evaporator 230 and then enter the compressor 250 by passing through the accumulator 240.

The accumulator 240 may function to prevent the liquid refrigerant from being supplied to the compressor. In addition, as shown in FIG. 6, in the hot gas mode (second heating mode), the accumulator 240 may convert the two-phase refrigerant into the gaseous refrigerant by mixing and exchanging heat between the low-temperature and low-pressure two-phase refrigerant that passed through the evaporator 230 and the medium-temperature gaseous refrigerant that passed through the hot gas bypass valve 260, thereby enabling response to a heating load while the heat absorption amount is insufficient. When the heat absorption amount is excessively high or low, an opening amount of the hot gas bypass valve 260 may be desired to be controlled so that the medium-temperature gaseous refrigerant supplied to the accumulator 240 by passing through the hot gas bypass valve 260 is increased. However, as the opening amount of the hot gas bypass valve 260 is increased, the high-temperature and high-pressure gaseous refrigerant supplied from the compressor 250 to the condenser 210 may be reduced, which may result in significantly lower efficiency of a heating system.

Therefore, in an embodiment of the present disclosure, in the hot gas mode (second heating mode), the hot gas mode heat source generator 400 may drive the driving motor of the electric automobile in the inefficient mode based on the inefficient current map to generate the PE heat source, thereby preventing the heat absorption amount that is excessively high or low. In other words, according to an embodiment of the present disclosure, in order to efficiently operate the hot gas mode while a waste heat source is insufficient, the PE heat source may be generated through inefficient control of the driving motor based on the inefficient current map, and enthalpy of the two-phase refrigerant passing through the evaporator 230 by the generated PE heat source may be increased, thereby increasing the energy efficiency of the heating system.

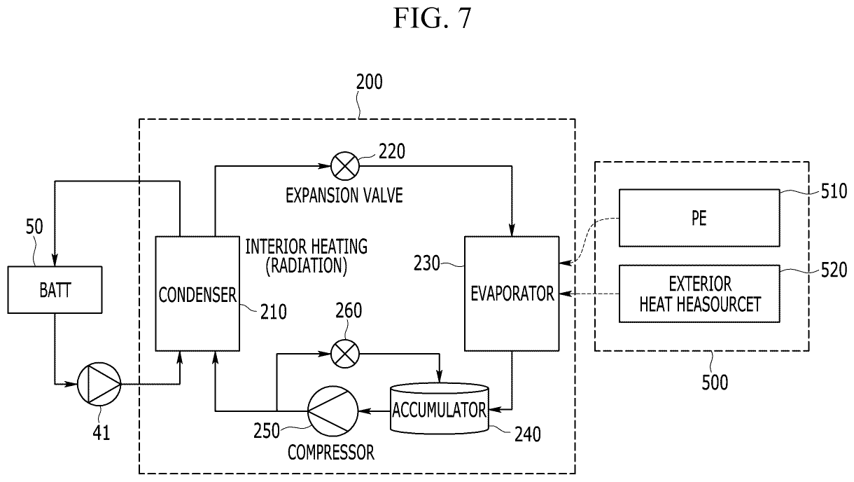

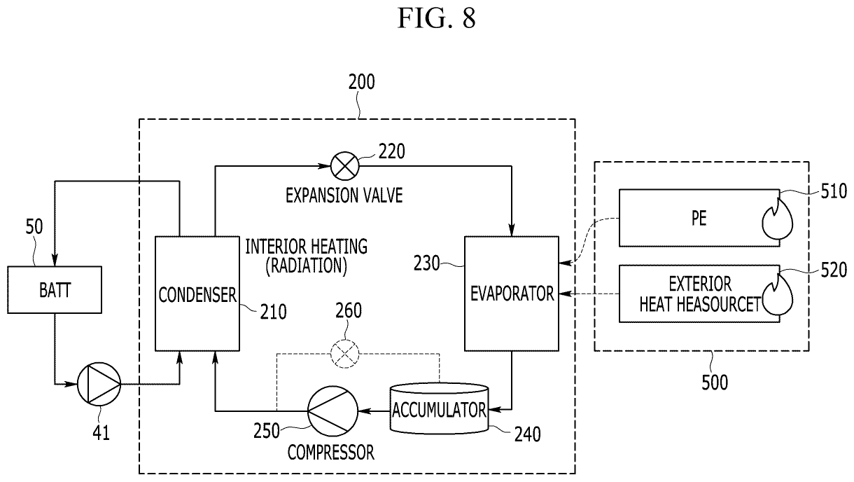

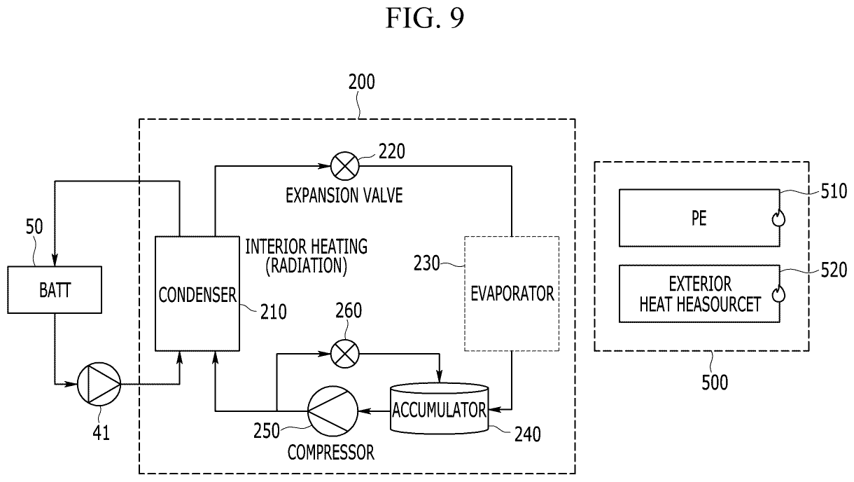

FIG. 7 is a diagram detailing a configuration of a hot gas heat pump device 200 according to another embodiment of the present disclosure. FIG. 8 is a diagram showing an operation of the hot gas heat pump device 200 of FIG. 7 in the heat pump mode. FIG. 9 is a diagram showing an operation of the hot gas heat pump device 200 of FIG. 7 in the hot gas mode. The hot gas heat pump device according to another embodiment of the present disclosure shown in FIGS. 7-9 may be used as a battery heating device.

Referring to FIG. 7, the hot gas heat pump device 200 used as the battery heating device may include the condenser 210, the expansion valve 220, the evaporator 230, the accumulator 240, the compressor 250, and a bypass valve 260. FIG. 7 shows a part that performs the same function as the component described with reference to FIG. 4, denoted by the same reference number as in FIG. 4, and its redundant description is thus omitted below.

The compressor 250 may compress the gaseous refrigerant supplied from the evaporator 230 to discharge the high-temperature and high-pressure gaseous refrigerant, and transmit the discharged gaseous refrigerant to the condenser 210. The high-temperature and high-pressure gaseous refrigerant discharged from the compressor 250 may be supplied entirely to the condenser 210 or partially branched and supplied to the bypass valve 260 based on a battery heating mode (first battery heating mode or second battery heating mode) under the control of the air conditioning control unit 100.

The bypass valve 260 may control a flow of the high-temperature and high-pressure gaseous refrigerant, branched and supplied from the compressor 250, under the control of the air conditioning control unit 100. In detail, as shown in FIG. 8, in the heat pump mode (first battery heating mode), the bypass valve 260 may block the path through which the high-temperature and high-pressure gaseous refrigerant branched and supplied from the compressor 250 re-enters the compressor 250. In addition, as shown in FIG. 9, in the hot gas mode (second battery heating mode), the bypass valve 260 may convert the high-temperature and high-pressure gaseous refrigerant branched and supplied from the compressor 250 into the medium-temperature gaseous refrigerant, thus allowing the refrigerant to enter the compressor 250 by passing through the accumulator 240.

The condenser 210 may release heat by condensing the high-temperature and high-pressure gaseous refrigerant that passed through the compressor 250, and convert the gaseous refrigerant into the high-temperature and high-pressure liquid refrigerant. Heat released from the condenser 210 may be used to heat the battery 50 directly or heat the battery 50 by heating and circulating the coolant flowing in a battery heating pipe (not shown) supplied to the battery 50 by driving an electronic water pump (also referred to as the “EWP”) 41.

According to an embodiment of the present disclosure, the air conditioning control unit 100 may perform both battery heating and automobile heating simultaneously in the heat pump mode (first battery heating mode). In this case, the coolant heated by the condenser 210 may be supplied for the battery heating and the automobile heating through a battery heating pipe (not shown) and an automobile interior heating pipe (not shown), respectively.

According to another embodiment of the present disclosure, the air conditioning control unit 100 may perform only the battery heating without performing the automobile heating in the hot gas mode (second battery heating mode). In this case, the coolant heated by the condenser 210 may be supplied to the battery 50 only through the battery heating pipe, and the coolant supplied to the automobile interior heating pipe (not shown) may be blocked by a valve (not shown). In addition, according to another embodiment of the present disclosure, in order to efficiently operate the hot gas mode (second battery heating mode) while waste heat source is insufficient, the heat source may be secured through the inefficient control of the driving motor, and the enthalpy of the two-phase refrigerant passing through the heat source from the evaporator 230 may be increased, thereby increasing the energy efficiency of the battery heating system.

The hot gas mode heat source generator 400 according to an embodiment of the present disclosure may use a motor driving system of an interior permanent magnet synchronous motor (hereinafter, referred to as “IPMSM”). In an embodiment of the present disclosure, the interior permanent magnet synchronous motor is described as an automobile driving motor. However, the present disclosure is not limited thereto, and the driving motor may also be applied to a surface mounted permanent magnet synchronous motor (SPMSM) or an induction motor.

In general, the driving motor may be controlled based on current vectors (id, iq) corresponding to the torque command, and a method for selecting the current vector may be classified into a method using a current vector selection algorithm and a method using the current map. In an embodiment of the present disclosure, a current control method using the two-dimensional current map (id, iq) may be applied to a driving motor system by considering the nonlinearity of the driving motor. In other words, in an embodiment of the present disclosure, a current command value corresponding to a torque command value may be generated from the pre-built two-dimensional current map (id, iq), and a motor torque may be controlled by controlling an inverter output based on the generated current command value.

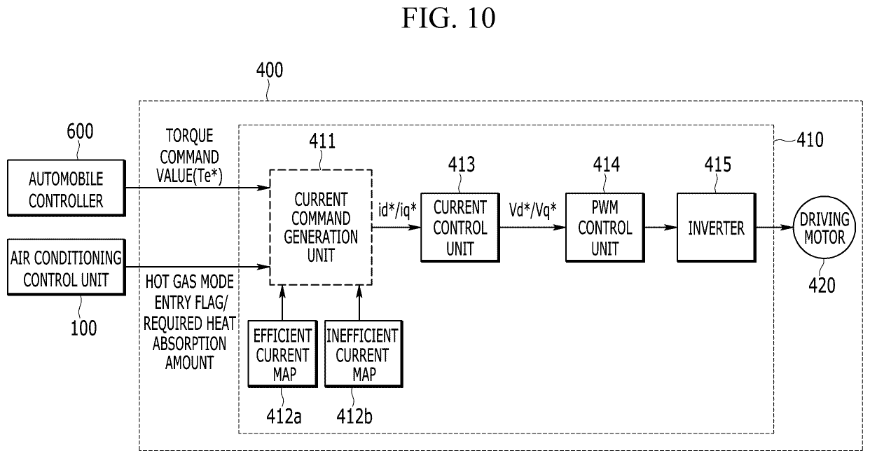

FIG. 10 is a diagram detailing a configuration of the hot gas mode heat source generator 400 according to an embodiment of the present disclosure.

Referring to FIG. 10, the hot gas mode heat source generator 400 according to an embodiment of the present disclosure may use the motor driving system using the current map, and include a motor control unit 410 and a driving motor 420.

The driving motor 420 may generate the torque by being operated by a three-phase alternating current (AC) voltage applied from the motor control unit 410. The driving motor 420 may be operated as a generator during towed driving or regenerative braking to supply the voltage to the battery.

The motor control unit 410 may control the torque and rotation speed of the driving motor based on a driver's intention, and may include a current command generation unit 411, an efficient current map 412a, an inefficient current map 412b, a current control unit 413, a pulse width modulation (PWM) control unit 414, and an inverter 415.

An automobile controller 600 may generate a corresponding torque command value Te* based on at least one of driving speed information, battery charge information, and electric load information of the automobile.

The current command generate unit 411 may receive the torque command value Te* received from the automobile controller 600, receive the hot gas mode entry flag and the heat absorption amount transmitted from the air conditioning control unit 100, and generate the current command value (current vector) based on the current map corresponding to the received torque command value, hot gas mode entry flag, and heat absorption amount. The current map may store a d-axis current command value (id*) and a q-axis current command value (iq*) corresponding to the torque and a magnetic flux in a table format. The current command generation unit 411 may output the current vector including the d-axis current command value (id*) and the q-axis current command value (iq*).

In detail, the current command generation unit 411 may generate the current command values (id*, iq*) corresponding to the torque command value by referring to the inefficient current map 412b corresponding to the heat absorption amount when the hot gas mode entry flag and the heat absorption amount are received, and generate the current command values (id*, iq*) corresponding to the torque command value by referring to the efficient current map 412a when the hot gas mode entry flag is not received. In an embodiment of the present disclosure, the current command generation unit 411 may generate the current command value by using the torque command, and the current battery voltage and speed of the motor as additional factors for feedback control.

According to an embodiment of the present disclosure, the efficient current map 412a may be pre-built through a maximum torque per ampere (MTPA) control method. The MTPA control method may also be referred to as maximum efficiency control because this method finds and uses a combination of current vectors (iq, id) that is capable of producing the maximum torque per unit current.

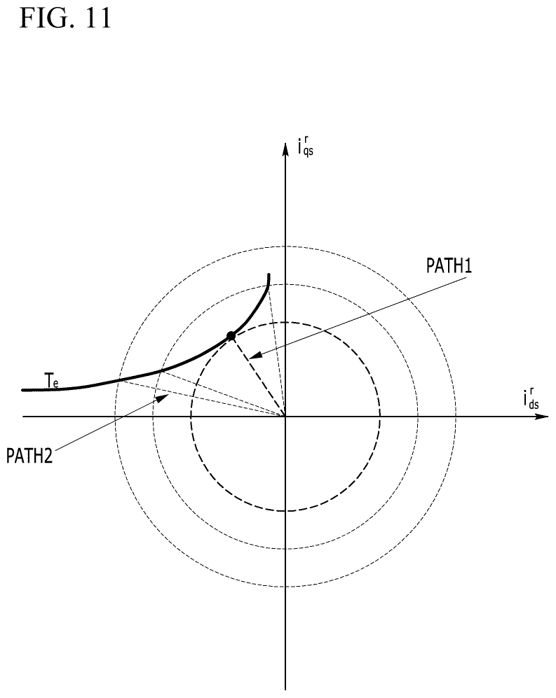

Referring to FIG. 11, a torque curve (equal torque curve) indicated by a solid line represents combinations of the current vectors (id, iq) that are capable of generating the same torque Te. In FIG. 11, a distance between the origin and the current vector indicates an effective value of the current. As shown in path 1, a point where a dotted circle is tangent to an equal torque curve (i.e., point where the distance from the origin to the equal torque curve is minimized) may correspond to the combination of the current vectors (iq, id) that minimizes the effective value of the current. The MTPA control method is a control method suitable for relatively energy-efficient driving because the method uses the minimum current to produce a desired torque, thus reducing a current-related loss. In an embodiment of the present disclosure, the efficient current map 412a may be pre-built by selecting the combination of the current vectors (iq, id) for each torque in order to select an operating point closest to the origin on the equal torque curve.

In an embodiment of the present disclosure, as shown in path 2, the inefficient current map 412b may be pre-built by selecting a point having a relatively long distance from the origin to the equal torque curve as the operating point. In other words, according to an embodiment of the present disclosure, the motor may be inefficiently driven in the hot gas mode by using the combination of the current vectors (iq, id) that corresponds to the pre-built inefficient current map 412b, thereby increasing heat generation (PE heat generation) due to the energy loss, and the heat generated here may be used for the automobile heating and the battery heating.

According to an embodiment of the present disclosure, an excessive current may cause the control of the driving motor to diverge, and the inefficient current map may be formed within a limit (inside a concentric circle in FIG. 11) that maintains current controllability.

In addition, in an embodiment of the present disclosure, a plurality of inefficient current maps 412b may be provided, and a heat generation amount of the PE heat source generated by the hot gas mode heat source generator 400 may vary depending on which of the plurality of inefficient current maps is selected to configure the combination of the current vectors.

According to an embodiment of the present disclosure, the combination of the current vectors (iq, id) is described being built as the efficient current map 412a based on the maximum efficiency control method as an example. However, the present disclosure is not limited thereto, and may include further building the current map based on a quick-response torque control method that primarily controls motor torque responsiveness for an automobile.

The current control unit 413 may generate voltage command values (Vd*, Vq*) by using a current command values (id*, iq*) output by the current command generation unit 411.

The PWM control unit 414 may generate a duty value (duty ratio) corresponding to the voltage command values (Vd*, Vq*) output by the current control unit 413, and control switches (not shown) in the inverter 415 based on the generated duty value.

The inverter 415 may convert a direct current (DC) voltage of the battery to thus generate the plurality of AC voltages having different phases, and drive the driving motor by varying a frequency of the AC voltage based on the duty value received from the PWM control unit 414.

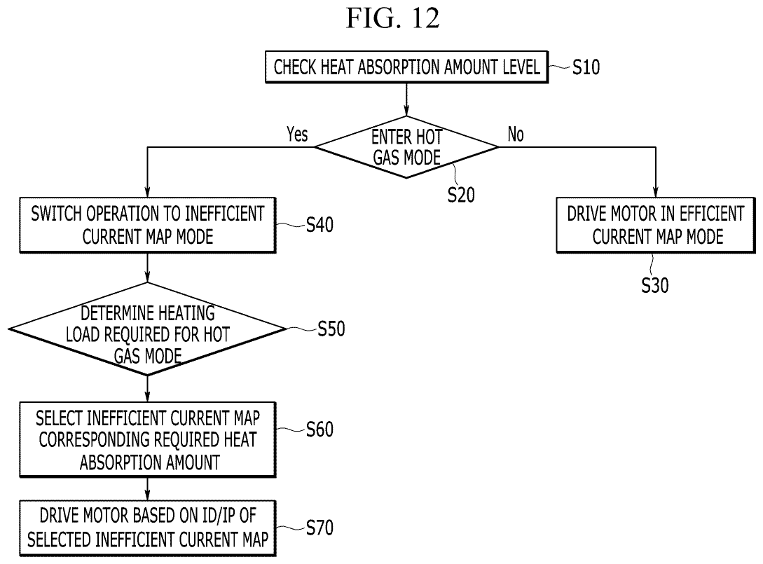

FIG. 12 is a flowchart of a control of the hot gas mode heat source generator 400 according to an embodiment of the present disclosure.

The air conditioning control unit 100 may check a heat absorption amount level based on the exterior temperature, PE temperature, battery temperature, or the like of the automobile, measured by the sensor unit 300 (S10), and determine whether to enter the hot gas mode based on the heat absorption amount level and a heating load (S20).

The heating load may be determined based on the automobile interior temperature, the automobile exterior temperature, and a customer's (e.g., users) heating set value.

The motor control unit 410 may control the driving motor in an efficient current map mode (S30) when the air conditioning control unit 100 determines that the heating load is satisfied in the heat pump mode (first heating mode) as a determination result in the step S20. In other words, the motor control unit 410 may generate the current command values (id, iq) from the efficient current map 412a based on the torque command value received from the automobile controller 600, and control the torque and the rotation speed of the driving motor based on the generated current command values (id, iq).

The hot gas mode entry flag may be transmitted to the motor control unit 410 of the hot gas mode heat source generator 400, and the motor control unit 410 may switch the operation to an inefficient current map mode (S40) when the air conditioning control unit 100 determines to enter the hot gas mode (second heating mode) as the determination result in the step S20.

The air conditioning control unit 100 may then determine the heat absorption amount in the hot gas mode in which the air conditioning control unit 100 may achieve the heating load, and transmit the determined heat absorption amount to the motor control unit 410 (S50). The heat absorption amount in the hot gas mode may be determined based on the heat absorption amount level based on the exterior temperature, PE temperature, battery temperature, or the like of the automobile and the heating load based on the automobile interior temperature, the automobile exterior temperature, and the customer's heating set value.

The current command generation unit 411 of the motor control unit 410 may select the inefficient current map capable of generating the heat absorption amount from the plurality of inefficient current maps 412b based on the hot gas mode entry flag and the heat absorption amount received from the air conditioning control unit 100. Additionally, the current command generation unit 411 may select the current command values (id, iq) corresponding to the torque command value (S60).

The motor control unit 410 may control the torque and the rotation speed of the driving motor based on the selected current command values (id, iq) (S70).

The steps may be performed in an appropriate order unless there is an explicit order or description to the contrary regarding the steps configuring the method according to this embodiment. The present disclosure is not necessarily limited to the order of the steps described above. Any use of examples or exemplary terms in the present disclosure is intended merely to describe the present disclosure in more detail, and does not limit the scope of the present disclosure. In addition, those having ordinary skill in the art would appreciate that various modifications, combinations, and changes may be made within the scope of the patent claims or their equivalents.

Although the embodiments of the present disclosure have been described in detail hereinabove, the scope of the present disclosure is not limited thereto. Various modifications and improvements made by those having ordinary skill in the art to which the present disclosure pertains also fall into the scope of the present disclosure.

What is claimed is:

1. An automotive hot gas heat pump system, the system comprising:
a sensor unit configured to measure a temperature of at least one of a exterior heat source, a power electronics (PE) heat source, and a battery heat source of an automobile;
a hot gas heat pump device including a condenser configured to release heat by condensing a high-temperature and high-pressure gaseous refrigerant supplied from a compressor and a hot gas bypass valve configured to open and close a path through which the high-temperature and high-pressure gaseous refrigerant branched and supplied from the compressor enters the compressor, and operate in a normal heat pump mode or a hot gas mode in response to the opening or closing operation of the hot gas bypass valve;
an air conditioning control unit configured to control the hot gas heat pump device to be operated in the normal heat pump mode or the hot gas mode based on a heat absorption amount based on the temperature measured by the sensor unit and a heating load, and generate a hot gas mode entry flag when the hot gas heat pump device is operated in the hot gas mode; and
a hot gas mode heat source generator configured to extract a current vector from an inefficient current map in response to a torque command value received from an automobile controller, and generate the PE heat source by driving a driving motor in an inefficient mode based on the extracted current vector, in response to the hot gas mode entry flag received from the air conditioning control unit.

2. The system of claim 1, wherein the air conditioning control unit generates a heat absorption amount for the operation in the hot gas mode, and
wherein the hot gas mode heat source generator extracts the current vector from the inefficient current map in response to the heat absorption amount generated by the air conditioning control unit and the torque command value received from the automobile controller.

3. The system of claim 2, wherein the hot gas heat pump device comprises:
the condenser configured to release heat by condensing the high-temperature and high-pressure gaseous refrigerant that passed through the compressor and convert the high-temperature and high-pressure gaseous refrigerant into a high-temperature and high-pressure liquid refrigerant;
an expansion valve configured to generate a low-temperature and low-pressure two-phase refrigerant by expanding the high-temperature and high-pressure liquid refrigerant supplied from the condenser;
an evaporator configured to convert the low-temperature and low-pressure two-phase refrigerant into a low-temperature and low-pressure gaseous refrigerant by absorbing heat from the exterior heat source;
the compressor configured to generate the high-temperature and high-pressure gaseous refrigerant by compressing the low-temperature and low-pressure gaseous refrigerant supplied from the evaporator, and provide the generated high-temperature and high-pressure gaseous refrigerant to the condenser;
the hot gas bypass valve configured to open and close the path through which the high-temperature and high-pressure gaseous refrigerant branched and supplied from the compressor enters the compressor, in response to the control of the air conditioning control unit; and
an accumulator disposed between the evaporator and the compressor, the accumulator being configured to prevent the liquid refrigerant from being supplied to the compressor.

4. The system of claim 3, wherein in the normal heat pump mode, the high-temperature and high-pressure gaseous refrigerant discharged from the compressor is entirely supplied to the condenser in response to the control of the air conditioning control unit, and
wherein in the hot gas mode, a portion of the high-temperature and high-pressure gaseous refrigerant discharged from the compressor is branched and converted into a medium-temperature gaseous refrigerant through the hot gas bypass valve and supplied to the compressor by passing through the accumulator.

5. The system of claim 4, wherein in the hot gas mode, the accumulator converts the low-temperature and low-pressure two-phase refrigerant into the low-temperature and low-pressure gaseous refrigerant by mixing and exchanging heat between the low-temperature and low-pressure two-phase refrigerant that passed through the evaporator and the medium-temperature gaseous refrigerant that passed through the hot gas bypass valve.

6. The system of claim 5, wherein heat released from the condenser is used for automobile heating.

7. The system of claim 5, wherein heat released from the condenser is used for battery heating.

8. The system of claim 1, wherein the hot gas mode heat source generator includes:
the driving motor configured to generate a torque by being operated by a three-phase alternating current (AC) voltage; and
a motor control unit configured to perform the inefficient control of the driving motor by using the inefficient current map.

9. The system of claim 8, wherein the motor control unit comprises:
an efficient current map configured to store a combination of the current vectors that is capable of producing a maximum torque per unit current in the driving motor;
the inefficient current map storing a combination of the current vectors for driving the driving motor in the inefficient mode;
a current command generation unit configured to generate a current command value from the inefficient current map based on the torque command value received from the automobile controller and the hot gas mode entry flag received from the air conditioning control unit;
a current control unit configured to generate a voltage command value by using the current command value generated by the current command generation unit;
a pulse width modulation (PWM) control unit configured to generate a duty value corresponding to the voltage command value generated by the current control unit; and
an inverter configured to drive the driving motor by varying a frequency of the AC voltage based on the duty value received from the PWM control unit.

10. The system of claim 9, wherein in the normal heat pump mode, the motor control unit controls the driving motor by generating the current command value from the efficient current map based on the torque command value received from the automobile controller.

11. The system of claim 9, wherein the inefficient current map comprises a plurality of inefficient current maps having different inefficient control levels of the driving motor, and
wherein the motor control unit selects a first inefficient current map corresponding to the heat absorption amount received from the air conditioning control unit from the plurality of inefficient current maps in response to the hot gas mode entry flag received from the air conditioning control unit, and controls the driving motor by selecting the current command value corresponding to the torque command value received from the automobile controller from the first inefficient current map.

12. A method of controlling an automotive hot gas heat pump system, the method comprising:
checking, by an air conditioning control unit of the automotive hot gas heat pump system, a heat absorption amount level based on a temperature of an exterior heat source measured by a sensor unit of the automotive hot gas heat pump system;
determining, by the air conditioning control unit, whether to enter a hot gas mode based on the heat absorption amount level and a heating load;
transmitting a hot gas mode entry flag to a hot gas mode heat source generator of the automotive hot gas heat pump system when it is determined, by the air conditioning control unit, to enter the hot gas mode;
extracting, by the hot gas mode heat source generator, a current vector from an inefficient current map in response to a torque command value received from an automobile controller; and
generating a power electronics (PE) heat source by driving a driving motor in an inefficient mode based on the extracted current vector, in response to the hot gas mode entry flag received from the air conditioning control unit.

13. The method of claim 12, further comprising:
determining a heat absorption amount in the hot gas mode in which the air conditioning control unit is capable of achieving the heating load,
wherein in the generating of the PE heat source, the current vector is extracted from the inefficient current map in response to the heat absorption amount received from the air conditioning control unit and the torque command value received from the automobile controller.

14. The method of claim 13, wherein the hot gas mode heat source generator comprises:
the driving motor configured to generate a torque by being operated by a three-phase alternating current (AC) voltage;
an efficient current map configured to store a combination of the current vectors that is capable of producing a maximum torque per unit current in the driving motor;
the inefficient current map configured to store a combination of the current vectors for driving the driving motor in the inefficient mode;
a current command generation unit configured to generate a current command value from the inefficient current map based on the torque command value received from the automobile controller and the hot gas mode entry flag received from the air conditioning control unit;
a current control unit configured to generate a voltage command value by using the current command value generated by the current command generation unit;
a pulse width modulation (PWM) control unit configured to generate a duty value corresponding to the voltage command value generated by the current control unit; and
an inverter configured to drive the driving motor by varying a frequency of the AC voltage based on the duty value received from the PWM control unit.

15. The method of claim 14, wherein the inefficient current map comprises a plurality of inefficient current maps having different inefficient control levels of the driving motor, and
wherein the generating of the PE heat source comprises:
selecting a first inefficient current map corresponding to the heat absorption amount received from the air conditioning control unit from the plurality of inefficient current maps in response to the hot gas mode entry flag received from the air conditioning control unit; and
controlling the driving motor by selecting the current command value corresponding to the torque command value received from the automobile controller from the first inefficient current map.

16. The method of claim 12, wherein the heating load is determined based on an interior temperature of an automobile, an exterior temperature of the automobile, and a heating set value of a customer.

17. A method of controlling an automotive hot gas heat pump system, the method comprising:
measuring, by a sensor unit of the automotive hot gas heat pump system, a temperature of at least one of an exterior heat source, a power electronics (PE) heat source, and a battery heat source of an automobile;
determining, by an air conditioning control unit of the automotive hot gas heat pump system, whether to operate a hot gas heat pump device of the automotive hot gas heat pump system in a normal heat pump mode or a hot gas mode based on a heat absorption amount based on the temperature measured by the sensor unit and a heating load;
generating, by the air conditioning control unit, a hot gas mode entry flag when the hot gas heat pump device is operated in the hot gas mode;
extracting, by a hot gas mode heat source generator, a current vector from an inefficient current map in response to a torque command value received from an automobile controller; and
generating, by the hot gas mode heat source generator, the PE heat source by driving a driving motor in an inefficient mode based on the extracted current vector, in response to the hot gas mode entry flag received from the air conditioning control unit.

18. The method of claim 17, wherein the hot gas heat pump device comprises:
a condenser configured to release heat by condensing a high-temperature and high-pressure gaseous refrigerant supplied from a compressor; and
a hot gas bypass valve configured to open and close a path through which the high-temperature and high-pressure gaseous refrigerant branched and supplied from the compressor enters the compressor,
wherein the hot gas heat pump device is configured to operate in the normal heat pump mode or the hot gas mode in response to the opening or closing operation of the hot gas bypass valve.

19. The method of claim 18, further comprising:
generating, by the air conditioning control unit, a heat absorption amount for the operation in the hot gas mode, and
extracting, by the hot gas mode heat source generator, the current vector from the inefficient current map in response to the heat absorption amount generated by the air conditioning control unit and the torque command value received from the automobile controller.

20. The method of claim 19, wherein the hot gas heat pump device comprises:
the condenser configured to release heat by condensing the high-temperature and high-pressure gaseous refrigerant that passed through the compressor and convert the high-temperature and high-pressure gaseous refrigerant into a high-temperature and high-pressure liquid refrigerant;
an expansion valve configured to generate a low-temperature and low-pressure two-phase refrigerant by expanding the high-temperature and high-pressure liquid refrigerant supplied from the condenser;
an evaporator configured to convert the low-temperature and low-pressure two-phase refrigerant into a low-temperature and low-pressure gaseous refrigerant by absorbing heat from the exterior heat source;
the compressor configured to generate the high-temperature and high-pressure gaseous refrigerant by compressing the low-temperature and low-pressure gaseous refrigerant supplied from the evaporator, and provide the generated high-temperature and high-pressure gaseous refrigerant to the condenser;
the hot gas bypass valve configured to open and close the path through which the high-temperature and high-pressure gaseous refrigerant branched and supplied from the compressor enters the compressor, in response to the control of the air conditioning control unit; and
an accumulator disposed between the evaporator and the compressor, the accumulator being configured to prevent the liquid refrigerant from being supplied to the compressor.
